(19) United States
(12) Patent Application Publication
(10) Pub. No.: US 2024/0090010 A1
(43) Pub. Date: Mar. 14, 2024

(54) LOW LATENCY DYNAMIC QUALITY OF SERVICE FEEDBACK REPORT

(71) Applicant: QUALCOMM Incorporated, San Diego, CA (US)

(72) Inventors: Abdel Karim Ajami, Lakeside, CA (US); Sai Yiu Duncan Ho, San Diego, CA (US); Alfred Asterjadhi, San Diego, CA (US); George Cherian, San Diego, CA (US); Abhishek Pramod Patil, San Diego, CA (US); Yanjun Sun, San Diego, CA (US); Gaurang Naik, San Diego, CA (US); Naveen Gangadharan, San Jose, CA (US); Nathaniel David Houghton, El Cerrito, CA (US); Srinivas Katar, Fremont, CA (US); Xiaolong Huang, Santee, CA (US)

(21) Appl. No.: 17/931,524

(22) Filed: Sep. 12, 2022

(51) Int. Cl. H04W 72/08; H04W 24/10

(52) U.S. Cl. CPC H04W 72/085; H04W 24/10

(57) ABSTRACT

Techniques related to wireless communication are disclosed. Some aspects of the disclosure relate to devices and methods for improving a quality of service (QoS) by reporting near-real-time feedback relating to a delay experienced by packets queued for transmission, and dynamically scheduling a wireless station to transmit and meet its QoS. A wireless station (STA) obtains one or more packets for transmission, the packets being associated with a delay condition. The STA outputs for transmission a delay status report that includes information relating to the delay condition associated with the one or more packets. In response, the STA obtains a resource allocation for transmission of the one or more packets according to the information relating to the delay condition. Other aspects, embodiments, and features are also claimed and described.

### TECHNICAL FIELD

The technology discussed below relates generally to wireless communication systems, and more particularly, to low-latency wireless communications.

### INTRODUCTION

In a wireless communication system, the quality of service (QoS) refers to the overall performance of the communication service. Many different parameters may be used to quantify a QoS, including a maximum packet delay time or latency, a packet loss rate, a bit rate, among other parameters.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

Various aspects of this disclosure relate to feedback that a wireless client can provide to an access point. This feedback relates to the packet delay the client is experiencing, for the purpose of dynamic scheduling of the client to achieve a low latency QoS.

In one aspect, this disclosure provides an apparatus configured for wireless communication. The apparatus includes a memory and a processor coupled to the memory. The processor is configured to obtain one or more packets for transmission, the one or more packets being associated with a delay condition. The processor is further configured to output, for transmission, a report including information relating to the delay condition associated with the one or more packets. The processor is further configured to obtain a resource allocation for transmission of the one or more packets according to the information relating to the delay condition.

In yet another aspect, this disclosure provides a station configured for wireless communication. The station includes a memory including instructions, a transceiver, and a processor configured to execute the instructions. The processor is configured cause the station to obtain one or more packets for transmission, the one or more packets being associated with a delay condition. The processor is further configured to transmit, via the transceiver, a report including information relating to the delay condition associated with the one or more packets. The processor is further configured to receive, via the transceiver, a resource allocation for transmission of the one or more packets according to the information relating to the delay condition.

In another aspect, this disclosure provides an apparatus configured for wireless communication. The apparatus includes a memory and a processor coupled to the memory. The processor is configured to obtain a report from a station, the report including information relating to a delay condition associated with one or more packets for transmission. The processor is further configured to schedule resources for the station to transmit the one or more packets based on the information relating to the delay condition. The processor is further configured to output, for transmission to the station, a resource allocation configuring the station to transmit the one or more packets according to the scheduled resources.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication network according to some aspects of the disclosure.

FIG. 2 is a schematic illustration of a multi-antenna wireless communication system according to some aspects of the disclosure.

FIG. 3 is a call flow diagram illustrating exemplary operations for reporting a real-time delay status according to some aspects of the disclosure.

FIG. 4 is a diagram illustrating a capability information message according to some aspects of the disclosure.

FIG. 5 is a diagram illustrating a delay status report according to some aspects of the disclosure.

FIG. 6 is a table illustrating a type or category subfield according to some aspects of the disclosure.

FIG. 7 is a table illustrating a queue size scaling factor subfield according to some aspects of the disclosure.

FIG. 8 is a block diagram of an exemplary station (STA) according to some aspects of the disclosure.

FIG. 9 is a block diagram of an exemplary access point (AP) according to some aspects of the disclosure.

FIG. 10 is a flow chart illustrating an exemplary process for a STA according to some aspects of the disclosure.

FIG. 11 is a flow chart illustrating an exemplary process for an AP according to some aspects of the disclosure.

### DETAILED DESCRIPTION

Aspects of this disclosure describe apparatuses, methods, processing systems, and computer-readable media for the use of a quality of service (QoS) status report as a feedback message to improve the QoS in a latency-sensitive system.

In IEEE 802.11be (also referred to as Wi-Fi 7) or in next generation Wi-Fi networks that may require ultra-high reliability, a framework has been introduced called the multi-link stream classification service (SCS) framework. With this framework, a wireless station (STA) may negotiate a set of QoS parameters with its access point (AP), e.g., at the start of a QoS session. These parameters can include a packet delay bound, a MAC service data unit (MSDU) delivery ratio, a mean data rate, among others. However, the multi-link SCS framework can fail to achieve a desired QoS in certain circumstances. For example, stations or flows that have packets with a long head-of-line delay may not be scheduled with priority over other packets or flows, causing the station to fail to meet its QoS requirements and drop packets.

Aspects of this disclosure provide a dynamic mechanism whereby a station may report, to an access point, information about the experienced real-time delay for packets that are currently in the station's queue. Further aspects of this disclosure describe a dynamic mechanism for a station to report the real-time delay bound, after which the station may start to drop the latency-sensitive packets. By virtue of this feedback reporting, the access point is enabled to react quickly to ensure that the station's QoS is met by scheduling or triggering the station in the uplink before the delay bound is met.

### Introduction to Wireless Communications Networks

Various aspects of the disclosure are described more fully hereinafter with reference to the accompanying drawings. This disclosure may, however, be implemented in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be implemented by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communications systems, including communications systems that are based on an orthogonal multiplexing scheme. Examples of such communications systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (such as implemented within or performed by) a variety of wired or wireless apparatuses (such as nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”). Radio Router. Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (such as a cellular phone or smart phone), a computer (such as a laptop), a tablet, a portable communications device, a portable computing device (such as a personal data assistant), an entertainment device (such as a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (such as a wide area network such as the Internet or a cellular network) via a wired or wireless communications link.

### Example Wireless Communications System

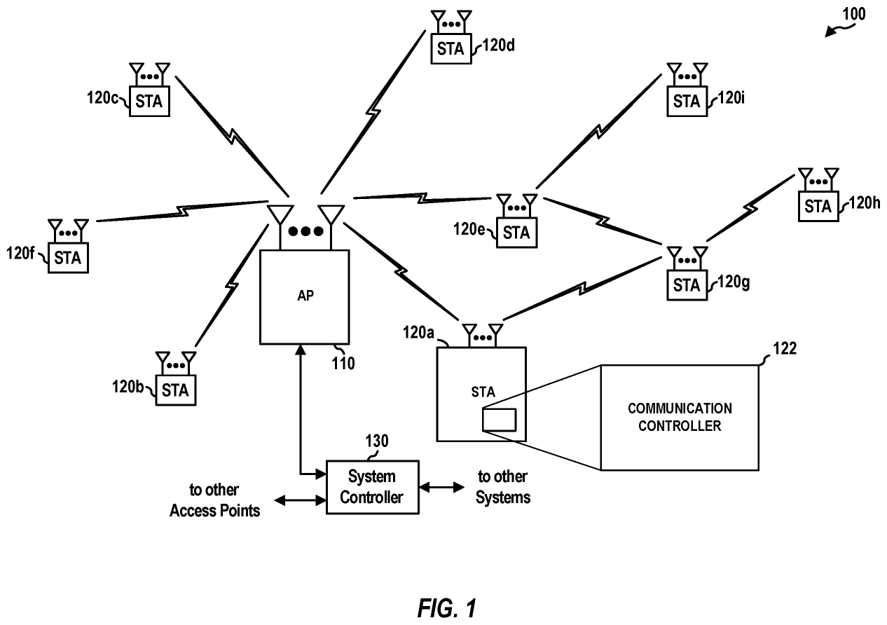

FIG. 1 is a diagram illustrating an example wireless communication system 100, in accordance with certain aspects of the present disclosure. System 100 may be a multiple-input multiple-output (MIMO)/multi-link operation (MLO) system 100. The wireless station (STA) 120a includes a communication controller 122 that may be configured to take one or more actions described herein.

For simplicity, only one AP 110 is shown in FIG. 1. An AP is generally a fixed station that communicates with the wireless STAs and may also be referred to as a base station (BS) or some other terminology. A wireless STA may be fixed or mobile and may also be referred to as a mobile STA, a wireless device, or some other terminology. AP 110 may communicate with one or more wireless STAs 120 at any given moment on the downlink (DL) and/or uplink (UL). The DL (i.e., forward link) is the communication link from AP 110 to the wireless STAs 120, and the UL (i.e., reverse link) is the communication link from the wireless STAs 120 to AP 110. A wireless STA 120 may also communicate peer-to-peer with another wireless STA 120, for example, via a direct link such as a tunneled direct link setup (TDLS). A system controller 130 may be in communication with and provide coordination and control for the access points.

While portions of the following disclosure will describe wireless STAs 120 capable of communicating via Spatial Division Multiple Access (SDMA), for certain aspects, the wireless STAs 120 may also include some wireless STAs 120 that do not support SDMA. Thus, for such aspects, an AP 110 may be configured to communicate with both SDMA and non-SDMA wireless STAs 120. This approach may conveniently allow older versions of wireless STAs 120 (“legacy” stations) to remain deployed in an enterprise, extending their useful lifetime, while allowing newer SDMA wireless STAs 120 to be introduced as deemed appropriate.

System 100 employs multiple transmit and multiple receive antennas for data transmission on the DL and UL. AP 110 is equipped with Nₐₚ antennas and represents the multiple-input (MI) for DL transmissions and the multiple-output (MO) for UL transmissions. A set of K selected wireless stations 120 collectively represents the multiple-output for DL transmissions and the multiple-input for UL transmissions. For pure SDMA, it is desired to have Nₐₚ≥K≥1 if the data symbol streams for the K wireless STAs are not multiplexed in code, frequency, or time by some means. K may be greater than Nₐₚ if the data symbol streams can be multiplexed using a TDMA technique, different code channels with CDMA, disjoint sets of subbands with OFDM, and so on. Each selected wireless STA transmits user-specific data to and/or receives user-specific data from the access point. In general, each selected wireless STA may be equipped with one or multiple antennas (i.e., Nₛₜₐ≥1). The K selected wireless STAs can have the same or different number of antennas.

The AP 110 may periodically (e.g., every 100 TU) broadcast beacon frames to enable the STAs 120a-120i and other wireless devices within wireless range of the AP 110 to establish and maintain a communication link with the AP 110. The beacon frames, which may indicate downlink (DL) data transmissions to the STAs 120a-120i and solicit or schedule uplink (UL) data transmissions from the STAs 120a-120i, are typically broadcast according to a target beacon transmission time (TBTT) schedule. The broadcasted beacon frames may include a timestamp field corresponding to a timing synchronization function (TSF) value of the AP 110. The STAs 120a-120i may synchronize their own local TSF values with the broadcasted TSF value, for example, so that all of the STAs 120a-120i are synchronized with each other and with the AP 110. That is, if a TSF timer at a STA is different from the timestamp received in the beacon, the receiving STA sets its local TSF timer to the received timestamp value. This way the STAs can synchronize their TSF timers with the AP.

System 100 may be a time division duplex (TDD) system or a frequency division duplex (FDD) system. For a TDD system, the DL and UL share the same carrier frequency. For an FDD system, the DL and UL use different carrier frequencies. System 100 may also utilize a single carrier or multiple carriers for transmission. Each wireless STA may be equipped with a single antenna or multiple antennas. System 100 may also be a TDMA system if wireless STAs 120 share the same carrier frequency by dividing transmission/reception into different time slots, each time slot being assigned to a different wireless STA 120. In accordance with the disclosure, as will be explained in more detail below, the STA 120a may be configured to transmit a delay status report including information relating to a delay condition of one or more packets queued for transmission. Further, the AP 110 may be configured to schedule resources for the STA 120a to transmit the queued packets based on the delay status report. In this manner, a wireless communication system 100 may improve a quality of service QoS in relation to low-latency packet communications.

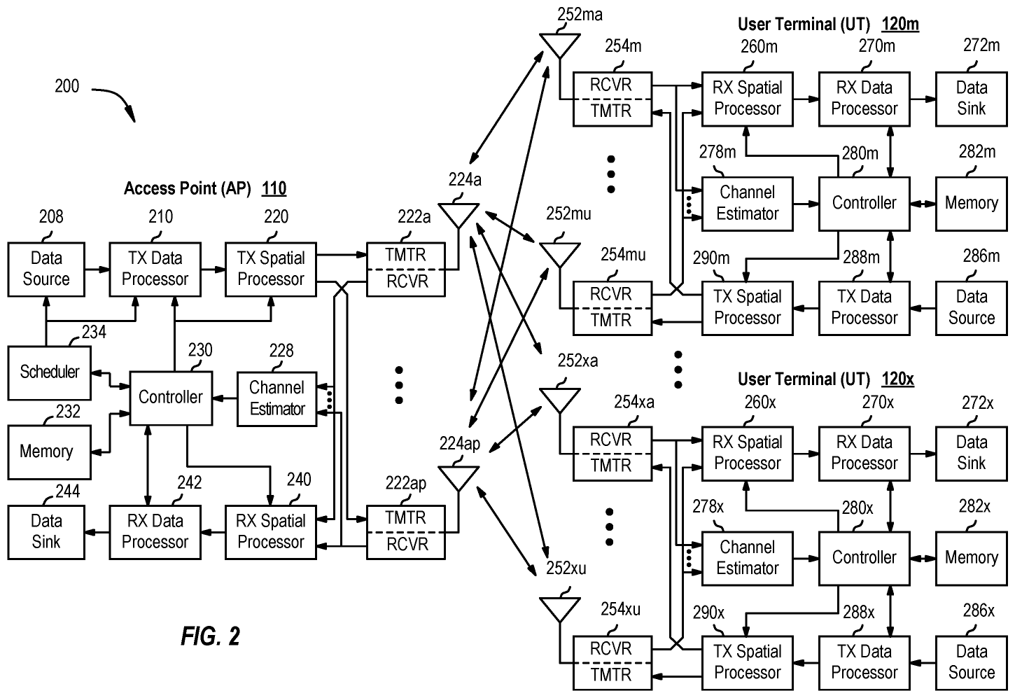

FIG. 2 illustrates a block diagram of AP 110 and two wireless STAs 120m and 120x in a MIMO/MLO system, such as system 100, in accordance with certain aspects of the present disclosure. In certain aspects, AP 110 and/or wireless STAs 120m and 120x may perform various techniques to ensure that a non-AP MLD is able to receive a group addressed frame. For example, AP 110 and/or wireless STAs 120m and 120x may include a respective association manager as described herein with respect to FIG. 1.

AP 110 is equipped with Nₐₚ antennas 224a through 224t. Wireless STA 120m is equipped with N_{sta,m} antennas 252ma through 252mu, and wireless STA 120x is equipped with N_{sta,x} antennas 252xa through 252xu. AP 110 is a transmitting entity for the DL and a receiving entity for the UL. Each wireless STA 120 is a transmitting entity for the UL and a receiving entity for the DL. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “DL” denotes the downlink, the subscript “UL” denotes the uplink, N_{UL} wireless STAs are selected for simultaneous transmission on the uplink, N_{DL} wireless STAs are selected for simultaneous transmission on the downlink, N_{UL} may or may not be equal to N_{DL}, and N_{UL} and N_{DL} may be static values or can change for each scheduling interval. Beam-steering or some other spatial processing technique may be used at the access point and wireless station.

On the UL, at each wireless STA 120 selected for UL transmission, a transmit (TX) data processor 288 receives traffic data from a data source 286 and control data from a controller 280. TX data processor 288 processes (e.g., encodes, interleaves, and modulates) the traffic data for the wireless station based on the coding and modulation schemes associated with the rate selected for the wireless STA and provides a data symbol stream. A TX spatial processor 290 performs spatial processing on the data symbol stream and provides N_{sta,m} transmit symbol streams for the N_{sta,m} antennas. Each transceiver (TMTR) 254 receives and processes (e.g., converts to analog, amplifies, filters, and frequency upconverts) a respective transmit symbol stream to generate an uplink signal. N_{sta,m} transceivers 254 provide N_{sta,m} UL signals for transmission from N_{sta,m} antennas 252 to AP 110.

N_{UL} wireless STAs may be scheduled for simultaneous transmission on the uplink. Each of these wireless STAs performs spatial processing on its data symbol stream and transmits its set of transmit symbol streams on the UL to the AP 110.

At AP 110, Nₐₚ antennas 224a through 224ap receive the UL signals from all N_{UL} wireless STAs transmitting on the UL. Each antenna 224 provides a received signal to a respective transceiver (RCVR) 222. Each transceiver 222 performs processing complementary to that performed by transceiver 254 and provides a received symbol stream. A receive (RX) spatial processor 240 performs receiver spatial processing on the Nₐₚ received symbol streams from Nₐₚ transceiver 222 and provides N_{UL} recovered UL data symbol streams. The receiver spatial processing is performed in accordance with the channel correlation matrix inversion (CCMI), minimum mean square error (MMSE), soft interference cancellation (SIC), or some other technique. Each recovered UL data symbol stream is an estimate of a data symbol stream transmitted by a respective wireless station. An RX data processor 242 processes (e.g., demodulates, deinterleaves, and decodes) each recovered uplink data symbol stream in accordance with the rate used for that stream to obtain decoded data. The decoded data for each wireless STA may be provided to a data sink 244 for storage and/or a controller 230 for further processing.

On the DL, at AP 110, a TX data processor 210 receives traffic data from a data source 208 for N_{DL} wireless stations scheduled for downlink transmission, control data from a controller 230, and possibly scheduling data from a scheduler 234. The various types of data may be sent on different transport channels. TX data processor 210 processes (e.g., encodes, interleaves, and modulates) the traffic data for each wireless station based on the rate selected for that wireless station. TX data processor 210 provides N_{DL} DL data symbol streams for the N_{DL} wireless stations. A TX spatial processor 220 performs spatial processing (such as a precoding or beamforming, as described in the present disclosure) on the N_{DL} DL data symbol streams, and provides Nₐₚ transmit symbol streams for the Nₐₚ antennas. Each transceiver 222 receives and processes a respective transmit symbol stream to generate a DL signal. Nₐₚ transceivers 222 providing Nₐₚ DL signals for transmission from Nₐₚ antennas 224 to the wireless STAs.

At each wireless STA 120, N_{sta,m} antennas 252 receive the Nₐₚ DL signals from access point 110. Each transceiver 254 processes a received signal from an associated antenna 252 and provides a received symbol stream. An RX spatial processor 260 performs receiver spatial processing on N_{sta,m} received symbol streams from N_{sta,m} transceiver 254 and provides a recovered DL data symbol stream for the wireless station. The receiver spatial processing is performed in accordance with the CCMI, MMSE or some other technique. An RX data processor 270 processes (e.g., demodulates, deinterleaves and decodes) the recovered DL data symbol stream to obtain decoded data for the wireless station.

At each wireless STA 120, a channel estimator 278 estimates the DL channel response and provides DL channel estimates, which may include channel gain estimates, SNR estimates, noise variance and so on. Similarly, a channel estimator 228 estimates the UL channel response and provides UL channel estimates. Controller 280 for each wireless STA typically derives the spatial filter matrix for the wireless station based on the downlink channel response matrix H_{dn,m} for that wireless station. Controller 230 derives the spatial filter matrix for the AP based on the effective UL channel response matrix H_{up,eff}. Controller 280 for each wireless STA may send feedback information (e.g., the downlink and/or uplink eigenvectors, eigenvalues, SNR estimates, and so on) to the AP. Controllers 230 and 280 also control the operation of various processing units at AP 110 and wireless STA 120, respectively.

### Aspects Related to QoS Feedback

According to some aspects of the disclosure, a station may transmit near-real-time feedback to an AP such as a QoS status report or delay status report including information relating to a packet delay. To reduce latency, this report may be provided in a MAC header, using packet delay information that may come from higher layers. For example, an application layer function may inform the MAC layer that a set of packets, or a flow, has a given packet delay budget (e.g., that packets should be transmitted within 5 ms or the application layer will drop the packets as they will no longer be useful to the application). Here, the delay status report may include information relating to this packet delay, such as a packet or flow identifier, the size of the queue or number of packets to be transmitted, and information about a packet delay for those packets. For example, the information about the packet delay may include the amount of time that has elapsed since the station received the corresponding head-of-the-line packet at the MAC layer. In another example, the information about the packet delay may include the delay bound, after which the station will not be able to meet its QoS requirements. Based on the report from a given station, an access point may schedule or trigger the station for transmission of its low-latency packet(s) in time to meet QoS requirements.

Although the feedback or report is referred to as a QoS status report or delay status report in this disclosure, it is not so limited. That is, any suitable name may be used to refer to feedback including information about a packet delay. Furthermore, although the report is presented as a new or standalone report, it is not so limited. That is, the real-time delay information may be carried in an existing report or request such as a buffer status report (BSR) or a transmission opportunity (TXOP) resource request, which are carried in an existing A-control field in the HE-variant HT control field. Moreover, although details of an exemplary report format are provided, this disclosure is not limited to the particular details of the disclosed format. In a particular example, some or all subfields may be omitted or altered within the full scope of this disclosure.

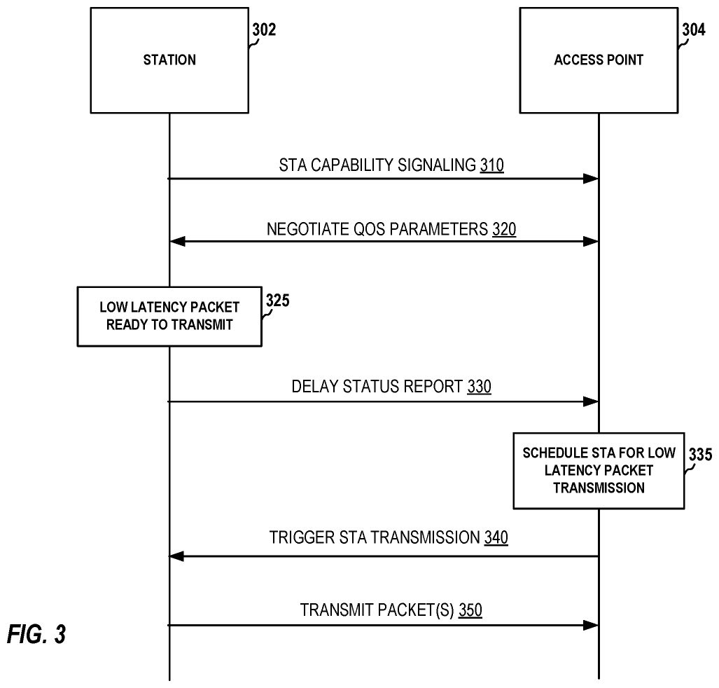

The techniques presented herein, providing for improved QoS for low latency packets, may be understood with reference to the example call flow diagram of FIG. 3. Although the example of FIG. 3 shows a non-AP STA 302 in communication with an AP 304, aspects of this disclosure are not limited thereto. That is, in other examples, either node in FIG. 3 may be a non-AP STA or an AP. For example, the STA 302 in FIG. 3 may be a non-AP STA (that may in some cases be a part of a multi-link device (MLD)), or an AP (that may also in some cases be part of an MLD). Similarly, the AP 304 in FIG. 3 may be a non-AP STA (that may in some cases be a part of an MLD), or an AP (that may also in some cases be part of an MLD).

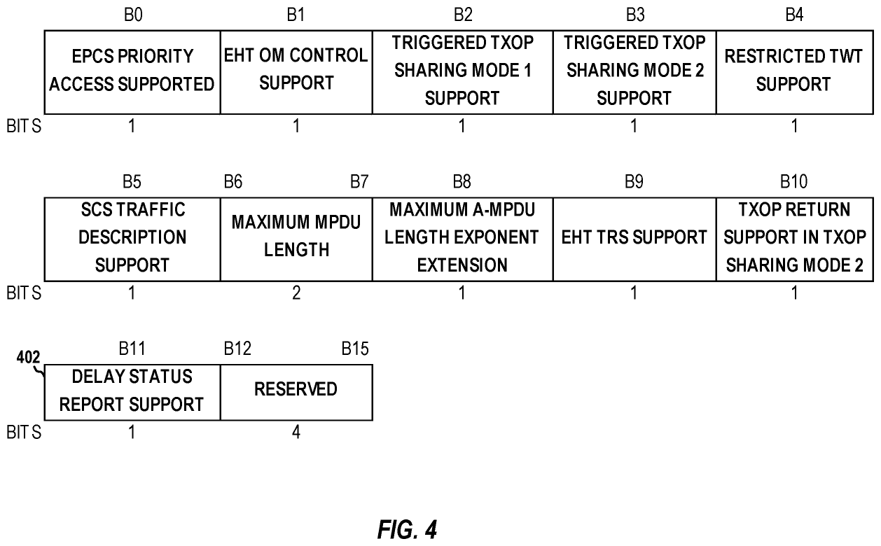

As shown in FIG. 3, a station (STA) 302 may transmit capability information signaling 310 to an access point (AP) 304. This illustrated capability signaling 310 may inform the AP 304 of the STA's capability to use a real-time delay status report feedback message relating to a packet delay in accordance with aspects of this disclosure. In another example (not illustrated), the AP 304 may transmit capability signaling to the STA 302 to inform the STA 302 of the AP's capability to use a real-time delay status report feedback message relating to a packet delay in accordance with aspects of this disclosure. Any suitable format may be used for the capability signaling 310. As one nonlimiting example, FIG. 4 shows an example of an extreme high throughput (EHT) capabilities element that indicates a set of capabilities that an EHT STA declares that it supports. Broadly, the EHT capabilities element shown in FIG. 4 indicates EHT MAC and PHY capabilities. The EHT capabilities element may be transmitted by a STA or AP before association or after association. Some examples of a message that may include the EHT capabilities element include a beacon frame, probe request and response frames, association request and response frames, TDLS setup frames, and others. As shown in FIG. 4, according to an aspect of this disclosure, an EHT capabilities element may include a one-bit delay status report support information element (IE) 402. Here, setting the corresponding bit indicates that a STA supports use of the delay status report for improved QoS performance. Of course, such a delay status report IE 402 may be included in any suitable message, and is not limited to the EHT capabilities element illustrated in FIG. 4. Moreover, a delay status report IE 402 may include any suitable number of bits, and is not limited to the one-bit example illustrated in FIG. 4.

In a further aspect, the STA 302 may utilize the capability information signaling 310 or other suitable message to suspend or resume usage of the delay status report feature. That is, a STA 302 may suspend or resume usage of the delay status report feature by transmitting a corresponding frame to the AP 304.

Returning to FIG. 3, at 320 the STA 302 and the AP 304 may negotiate a set of QoS parameters at the start of a QoS session, e.g., as per the multi-link SCS procedure defined in IEEE specifications for 802.11be, known to those of ordinary skill in the art. This negotiation may establish any suitable set of parameters for the QoS session, including a delay bound, an MSDU delivery ratio, and/or a mean data rate, among others.

At 325 the STA 302 may obtain one or more low-latency packets for transmission. For example, a data source 286 and/or a TX data processor 288 may have a set of one or more packets queued (e.g., in memory 282) for transmission at 325. The delay status report 330 may be transmitted in response to the low-latency packets being queued for transmission. In another example (not illustrated), the AP 304 may transmit a request to the STA, for the STA to transmit the delay status report 330. This delay status report request may be transmitted using anew or existing trigger frame, including but not limited to a buffer status report poll (BSRP) trigger frame.

At 330 the STA 302 may transmit a delay status report, including information relating to a packet delay. For example, a delay status report subfield may be defined as an A-control subfield in a MAC frame header. Here, the MAC header includes a high throughput (HT) control field. Wi-Fi 6 has defined a variant of the HT control field, called the high efficiency (HE) variant. The HE variant HT control field includes a field called an A-control subfield. In some examples, the STA 302 may transmit the delay status report 330 in a delay status report subfield of a QoS data frame or a QoS null frame.

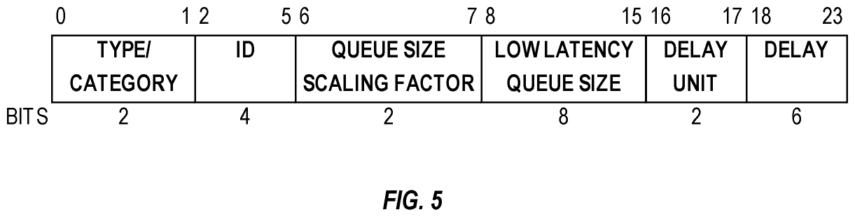

Among other things, the delay status report includes reported near-real-time delay information for frames scheduled for transmission by a STA in the uplink. FIG. 5 is an illustration of an A-control subfield corresponding to a delay status report according to some aspects of this disclosure. Although FIG. 5 illustrates a particular report format, this disclosure is not limited thereto, and any suitable format may be employed. In the illustrated example, the A-control subfield includes 24 bits allocated as follows:
Type/Category subfield: 2 bits
ID subfield: 4 bits
Queue size scaling factor field: 2 bits
Low latency queue size field: 8 bits
Delay unit subfield: 2 bits
Delay subfield: 6 bits
These subfields of the A-control subfield are described below.

### Type/Category Subfield

A type or category subfield may indicate a type or category of the information relating to the delay condition. That is, the delay subfield (described further below) may be configured to carry one of multiple types or categories of information relating to a delay condition. The type subfield can indicate which type or category of information the delay subfield carries.

For example, the type subfield may indicate that the delay subfield provides an amount of time that has elapsed since obtaining the packet(s) for transmission (e.g., a residence time of a head-of-the-line (HOL) packet for transmission).

In another example, the type subfield may indicate that the delay subfield provides a delay bound corresponding to the packet(s) for transmission. For example, the delay subfield may indicate a maximum delay corresponding to a set of one or more packets before the application will begin to drop the packet(s).

In another example, the type subfield may indicate that the delay subfield provides a delay bound corresponding to a subset of the packet(s). For example, the delay subfield may indicate a percentile (% ile), such as 95% ile or 99% ile, indicating that 95% or 99% of the packets should be transmitted within a given delay bound.

In another example, the type subfield may indicate that the delay subfield provides an average delay bound corresponding to the packet(s). For example, the delay subfield may indicate an average delay bound for a set of packets queued for transmission.

In yet another example, the type subfield may indicate that the delay subfield provides the time that a HOL packet arrived at the MAC layer with respect to the TSF timer (described above). That is, the delay subfield may provide the TSF time when the HOL packet was queued.

In yet another example, the type subfield may indicate that the delay subfield provides the real-time delay bound with respect to the TSF timer. For instance, the delay subfield may report the minimum time with respect to the TSF timer at which the AP is expected to schedule or trigger the client, otherwise the client may drop the packet.

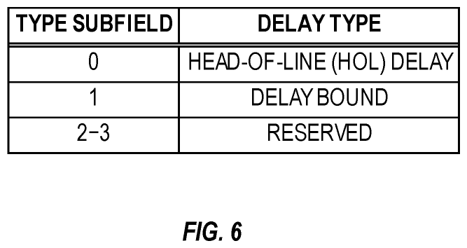

FIG. 6 illustrates one nonlimiting example table showing what values of the 2-bit type subfield may represent. In the illustrated example, a value of 0 in the type subfield indicates that the delay subfield provides a head-of-the-line (HOL) delay; a value of 1 in the type field indicates that the delay subfield provides a delay bound: and values of 2 and 3 are reserved for future use. Of course, values of 2 and/or 3 may be used in a given example to represent any suitable type or category including but not limited to those examples described above.

### ID Subfield

An ID subfield may indicate an identifier (ID) corresponding to the packet(s)(e.g., the ID of the traffic flow) associated with the delay condition. Any suitable ID may be utilized in an ID subfield, including but not limited to a traffic ID (TID), a stream classification service ID (SCSID), a target wake time (TWT) ID, etc. For example, the ID subfield may carry a 4-bit Traffic ID (TID), used in 802.11 specifications to classify the type of traffic. In another example, the ID subfield may carry an 8-bit stream classification service ID (SCSID). Here, the ID field may include further include information related to SCS protocols. In another example, the ID subfield may carry a target wake time (TWT) flow ID.

### Low Latency Queue Size Subfield

A low latency queue size subfield may generally indicate the size (e.g., in octets, in packets, or in any suitable units) of a queue of low latency packets that are ready for transmission. In some examples, the low latency queue size subfield may include 8-bits, although any suitable number of bits may be utilized within the scope of this disclosure. In an aspect of the disclosure, the low latency queue size subfield indicates the amount of low latency buffered traffic reported for the traffic flow ID identified by the ID subfield to be delivered to the STA identified by the receiver address of the frame containing the delay status report subfield.

### Queue Size Scaling Factor Subfield

A delay status report subfield that is implemented as an A-control subfield in a MAC frame header may have a limited size, such as 24 bits. Thus, a limited number of bits, such as the 8 bits described above in the exemplary queue size subfield, may be available for indicating a queue size. However, a queue size may be greater than 255 octets (the maximum number that can be indicated with 8 bits) in some examples. Therefore, according to a further aspect of the disclosure, a queue size scaling factor subfield may be included in a delay status report. Here, the queue size scaling factor may include a multiplication factor to be multiplied by the low latency queue size subfield to determine the low latency queue size.

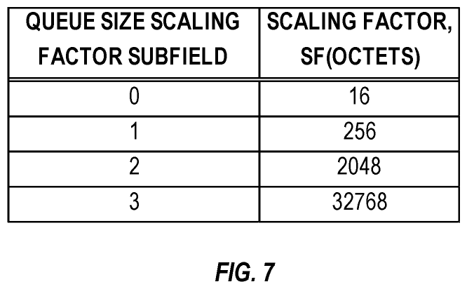

FIG. 7 illustrates one nonlimiting example of a table showing what values of a 2-bit queue size scaling factor subfield may represent. In the illustrated example, a queue size scaling factor subfield value of 0 indicates that the queue size is equal to the value in the queue size subfield multiplied by 16. A queue size scaling factor subfield value of 1 indicates that the queue size is equal to the value in the queue size subfield multiplied by 256. Of course, any suitable number of bits, and any suitable representation of multiplicands may be utilized in a given example.

### Delay Unit Subfield

A delay unit subfield may indicate the unit of time for the information relating to the delay condition. That is, the delay subfield (described further below) may be configured to carry information that indicates a length of time (e.g., a HOL delay or residence time of the HOL packet for transmission, a delay bound, etc.). To accommodate a broader range of potential time durations that can be indicated by the delay subfield, the delay unit subfield may be used for scaling the indicated duration of time.

In the example of FIG. 5, two bits are allocated to the delay unit subfield, providing for four possible values of the delay units. Of course, any suitable number of bits may be utilized in a delay unit subfield. Any suitable unit of time may be indicated in the delay unit subfield, e.g., 32 μs, 256 μs, 1 time unit (TU, equal to 1024 μs), etc.

### Delay Subfield

A delay subfield may carry information relating to a delay condition of one or more packet(s) (e.g., MAC service data units or MSDUs) ready for transmission. As described above, a type or category of information carried in the delay subfield may be indicated in the type subfield; and the units of the indicated delay may be indicated in a delay unit subfield. Information relating to a delay condition of one or more packets can include any suitable information relating to a delay condition of the packets. For example, the information relating to a delay condition may indicate a duration of delay already experienced by the associated packets. Note that here, the associated packets may include a HOL packet, and may not necessarily include current packets transmitted in the same frame as the delay status report. In another example, the information relating to a delay condition may indicate a delay bound beyond which the associated packets may be dropped. In yet another example, the information relating to a delay condition may indicate the TSF time when the HOL packet was queued. And in yet another example, the information relating to a delay condition may indicate the TSF time at which the HOL packets will be dropped.

In an example where the information relating to the delay condition indicates the TSF time when the HOL packet was queued (HOL packet enqueue time), the STA may report to the AP the enqueue time of the associated packet(s). In some examples, where the delay subfield corresponds to a HOL packet enqueue time, the delay subfield may specify the relevant TSF value (corresponding to an identified link), at which the STA has received the corresponding HOL packet at the local MAC layer entity. Here, the TSF value may be encoded such that the lowest bit of the HOL packet enqueue time corresponds to the starting bit of the relevant TSF value indicated by a TSF time encoding subfield (not illustrated). That is, a TSF time encoding subfield may indicate the encoding of the relevant TSF value at which the HOL packet was encoded. In other examples, the delay condition indicates the TSF time when the HOL packet will be dropped. For example, if the STA is aware of the delay bound of the traffic flow, the HOL packet drop time may be the TSF time when the HOL packet was enqueued plus the delay bound of the packet(s).

In some examples, the delay subfield may explicitly indicate a number of delay units (based on the delay unit subfield) relating to a delay (e.g., a HOL delay or a delay bound). In other examples, the delay subfield may indicate a range of times, with different values of the delay field representing different delay ranges. For example, one value in the delay subfield may indicate a range of 1 TU-2 TU, while another value in the delay subfield may indicate a different range, of 2 TU-3 TU. Of course, any suitable range or interval of time may be used in a given implementation, and the units of the delay may differ from TUs (e.g., the units may be indicated in the delay unit subfield).

In another aspect, the delay subfield may have one or more special values indicating information other than an explicit HOL packet enqueue time or a duration of a delay experienced by the associated packet(s). For example, the delay subfield may be set to a value of all 1's (e.g., 0b111111 for a 6-bit delay subfield) to indicate that the delay experienced by the associated packet(s) is greater than the maximum reported time (e.g., greater than the time corresponding to a value of 0b111110). In another example, the delay subfield may be set to a value of all 1's to indicate that the enqueue time is earlier than the earliest reported time (e.g., the time until the packet will be dropped is greater than the maximum reported time).

In still another example, a separate subfield (not illustrated) may be utilized to indicate that the delay experienced by the associated packet9s) is greater than the maximum reported time, or that the enqueue time is earlier than the earliest reported time.

Returning to FIG. 3, at 335 the access point 304 makes a scheduling decision, e.g., at scheduler 234. That is, the access point 304 schedules the STA for low-latency packet transmission based on the delay status report 330. Based on the delay status report, the AP can prioritize the STA relative to other clients based on the information relating to the delay condition of the packets ready for transmission.

At 340 the access point 304 transmits a resource allocation (e.g., a trigger frame) 340 to trigger the STA 302 to make an UL transmission, e.g., specifying the time and frequency resources for the STA to use. And at 350, the STA transmits its low latency packet(s) according to the trigger frame 340.

### Example Communication Devices

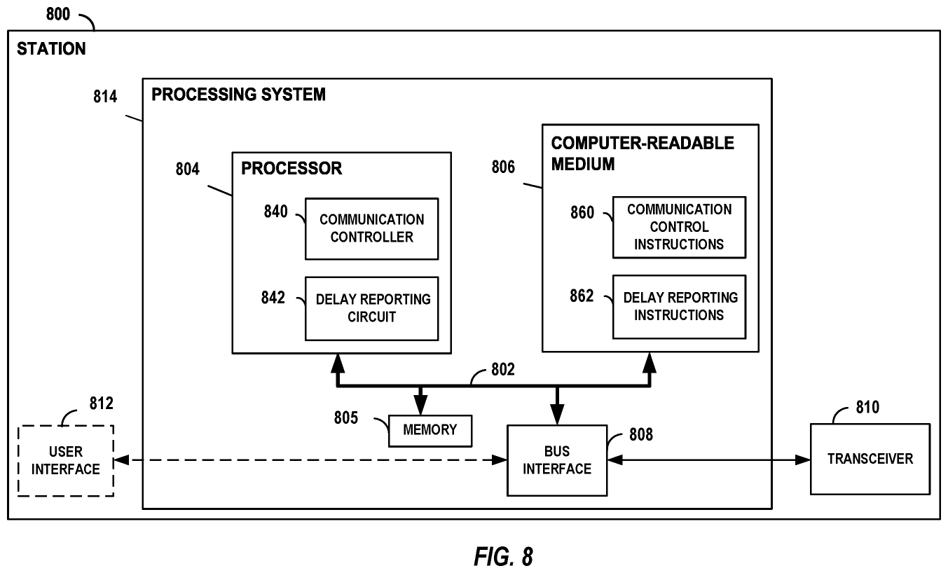

FIG. 8 is a block diagram illustrating an example of a hardware implementation for a STA 800 employing a processing system 814. For example, the STA 800 may be a station as illustrated in any one or more of FIGS. 1, 2, and/or 3.

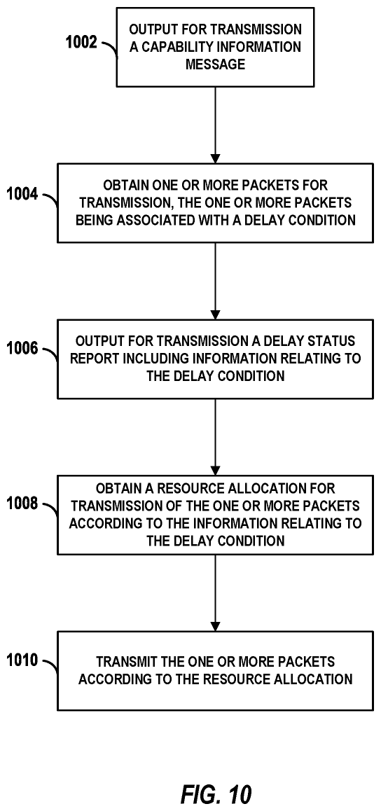

The STA 800 may include a processing system 814 having one or more processors 804. Examples of processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the STA 800 may be configured to perform any one or more of the functions described herein. For example, the processor 804, as utilized in a STA 800, may be configured (e.g., in coordination with the memory 805) to implement any one or more of the processes and procedures described below and illustrated in FIG. 10.

The processing system 814 may be implemented with a bus architecture, represented generally by the bus 802. The bus 802 may include any number of interconnecting buses and bridges depending on the specific application of the processing system 814 and the overall design constraints. The bus 802 communicatively couples together various circuits including one or more processors (represented generally by the processor 804), a memory 805, and computer-readable media (represented generally by the computer-readable medium 806). The bus 802 may also link various other circuits such as timing sources, peripherals, voltage regulators, and power management circuits, which are well known in the art, and therefore, will not be described any further. A bus interface 808 provides an interface between the bus 802 and a transceiver 810. The transceiver 810 provides a communication interface or means for communicating with various other apparatus over a transmission medium. Depending upon the nature of the apparatus, a user interface 812 (e.g., keypad, display, speaker, microphone, joystick) may also be provided. Of course, such a user interface 812 is optional, and some examples, such as a base station, may omit it.

In some aspects of the disclosure, the processor 804 may include a communication controller 840 configured (e.g., in coordination with the memory 805 and/or the transceiver 810) for various functions, including, e.g., outputting or transmitting messages to an AP, and obtaining or receiving messages from an AP. For example, the communication controller 840 may be configured to implement one or more of the functions described below in relation to FIG. 10, including, e.g., blocks 1002, 1004, 1008, and/or 1010.

The processor 804 may further include a delay reporting circuit 842 configured (e.g., in coordination with the memory 805 and/or the transceiver 810) for various functions, including, e.g., outputting for transmission a delay status report including information relating to a delay condition. For example, the delay reporting circuit 842 may be configured to implement one or more of the functions described below in relation to FIG. 10, including, e.g., block 1006.

The processor 804 is responsible for managing the bus 802 and general processing, including the execution of software stored on the computer-readable medium 806. The software, when executed by the processor 804, causes the processing system 814 to perform the various functions described below for any particular apparatus. The processor 804 may also use the computer-readable medium 806 and the memory 805 for storing data that the processor 804 manipulates when executing software.

One or more processors 804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 806. The computer-readable medium 806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 806 may reside in the processing system 814, external to the processing system 814, or distributed across multiple entities including the processing system 814. The computer-readable medium 806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 806 may store computer-executable code that includes communication control instructions 860 that configure a STA 800 for various functions, including, e.g., outputting or transmitting messages to an AP, and obtaining or receiving messages from an AP. For example, the communication control instructions 860 may be configured to cause a STA 800 to implement one or more of the functions described below in relation to FIG. 10, including, e.g., blocks 1002, 1004, 1008, and/or 1010.

The computer-readable storage medium 860 may further store computer-executable code that includes delay reporting instructions 862 that configure a STA 800 for various functions, including, e.g., outputting for transmission a delay status report including information relating to a delay condition. For example, the delay reporting instructions 862 may be configured to implement one or more of the functions described below in relation to FIG. 10, including, e.g., block 1006.

In one configuration, a STA 800 for wireless communication includes means for obtaining and/or receiving packets for transmission, means for obtaining and/or receiving a resource allocation, means for obtaining a capability information message from an access point, and means for outputting and/or transmitting a capability information message. In one aspect, the aforementioned means may be the processor 804 and/or the communication controller 840 configured to perform the functions recited by the aforementioned means. In another aspect, the aforementioned means may be a circuit or any apparatus configured to perform the functions recited by the aforementioned means.

In one configuration, a STA 800 for wireless communication includes means for outputting and/or transmitting a delay status report that includes information relating to a delay condition associated with one or more packets. In one aspect, the aforementioned means may be the processor 804 and/or the delay reporting circuit 842 configured to perform the functions recited by the aforementioned means. In another aspect, the aforementioned means may be a circuit or any apparatus configured to perform the functions recited by the aforementioned means.

Of course, in the above examples, the circuitry included in the processor 804 is merely provided as an example, and other means for carrying out the described functions may be included within various aspects of the present disclosure, including but not limited to the instructions stored in the computer-readable storage medium 806, or any other suitable apparatus or means described in any one of the FIGS. 1, 2, and/or 3, and utilizing, for example, the processes and/or algorithms described herein in relation to FIG. 10.

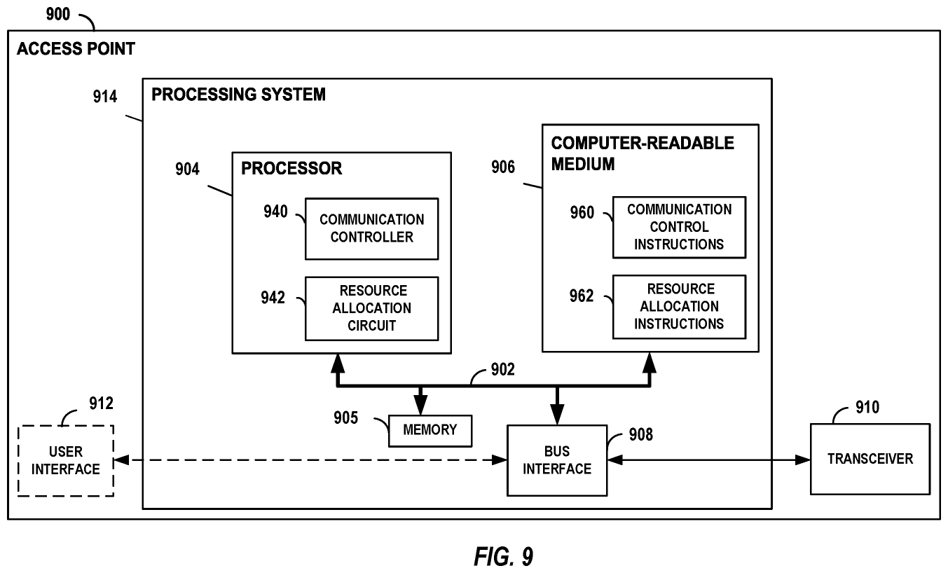

FIG. 9 is a conceptual diagram illustrating an example of a hardware implementation for an exemplary AP 900 employing a processing system 914. In accordance with various aspects of the disclosure, a processing system 914 may include an element, or any portion of an element, or any combination of elements having one or more processors 904. For example, the AP 900 may be an access point as illustrated in any one or more of FIGS. 1, 2, and/or 3.

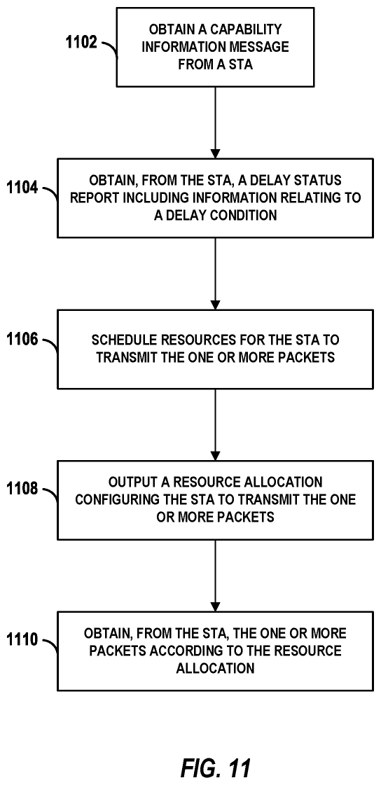

The processing system 914 may be substantially the same as the processing system 814 illustrated in FIG. 8, including a bus interface 908, a bus 902, memory 905, a processor 904, and a computer-readable medium 906. Furthermore, the UE 900 may include a user interface 912 and a transceiver 910 substantially similar to those described above in FIG. 8. That is, the processor 904, as utilized in a UE 900, may be configured (e.g., in coordination with the memory 905) to implement any one or more of the processes described below and illustrated in FIG. 11.

In some aspects of the disclosure, the processor 904 may include a communication controller 940 configured (e.g., in coordination with the memory 905 and/or the transceiver 910) for various functions, including, for example, outputting or transmitting messages to a STA, and obtaining or receiving messages from a STA. For example, the communication controller 940 may be configured to implement one or more of the functions described below in relation to FIG. 11, including, e.g., blocks 1102, 1104, 1108, and/or 1110.

The processor 904 may further include a resource allocation circuit 942 configured for various functions, including, for example, scheduling resources for a STA to transmit one or more packets. For example, the resource allocation circuit 942 may be configured to implement one or more of the functions described below in relation to FIG. 11, including, e.g., block 1106.

And further, the computer-readable storage medium 906 may store computer-executable code that includes communication control instructions 960 that configure an AP 900 for various functions, including. e.g., outputting or transmitting messages to a STA, and obtaining or receiving messages from a STA. For example, the communication control instructions 960 may be configured to cause an AP 900 to implement one or more of the functions described below in relation to FIG. 11, including, e.g., blocks 1102, 1104, 1108, and/or 1110.

The computer-readable storage medium 906 may further store computer-executable code that includes resource allocation instructions 962 that configure an AP 900 for various functions, including, e.g., scheduling resources for a STA to transmit one or more packets based on information relating to a delay condition. For example, the resource allocation instructions 962 may be configured to cause the AP 900 to implement one or more of the functions described below in relation to FIG. 11, including, e.g., block 1106.

In one configuration, an AP 900 for wireless communication includes means for obtaining and/or receiving a delay status report from a STA, means for outputting and/or transmitting a resource allocation, means for outputting a capability information message, and means for obtaining and/or receiving a capability information message from a STA. In one aspect, the aforementioned means may be the processor 904 and/or the communication controller 940 shown in 9 FIG. configured to perform the functions recited by the aforementioned means. In another aspect, the aforementioned means may be a circuit or any apparatus configured to perform the functions recited by the aforementioned means.

In one configuration, the AP 900 for wireless communication includes means for scheduling resources for a STA to transmit one or more packets based on information relating to a delay condition, means for prioritizing a STA relative to other STAs, and means for multiplying. In one aspect, the aforementioned means may be the processor 904 and/or the resource allocation circuit 942 shown in FIG. 9 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1, 2, and/or 3, and utilizing, for example, the processes and/or algorithms described herein in relation to FIG. 11.

### Example Operations of a Station

FIG. 10 is a flow chart illustrating an exemplary process 1000 for a station in accordance with some aspects of the present disclosure. As described below, a particular implementation may omit some or all illustrated features, and may not require some illustrated features to implement all embodiments. In some examples, the STA 800 illustrated in FIG. 8 may be configured to carry out the process 1000. In some examples, any suitable apparatus or means for carrying out the functions or algorithm described below may carry out the process 1000.

At block 1002, the STA 800 may output a capability information message. The capability information message may be any suitable message in any suitable format, indicating a STA capability of using the delay status report message. That is, the STA 800 may inform the AP that it has a capability to dynamically report the delay status report message for reduced latency and improved QoS. In some examples, the communication controller 840 (e.g., in coordination with the transceiver 810) may be configured to output the capability information message.

At block 1004, the STA 800 may obtain one or more packets for transmission. For example, an application may send a set of one or more packets to a MAC layer for transmission over a network. Here, the packets are associated with a delay condition. For example, a delay condition may be a HOL delay already experienced by the HOL packet. In another example, a delay condition may be a delay bound corresponding to the one or more packets. In yet another example, a delay condition may be a delay bound corresponding to a subset of the one or more packets (e.g., a 99% ile, 95% ile, etc.). And in yet another example, a delay condition may be an average delay bound corresponding to the one or more packets. In some examples, the communication controller 840 (e.g., in coordination with the transceiver 810) may obtain the one or more packets for transmission.

At block 1006, the STA 800 may output, for transmission, a delay status report including information relating to the delay condition associated with the one or more packets obtained at block 1004. For example, a delay status report may include a delay subfield as described above with reference to FIG. 5. In further examples, a delay status report may include one or more of a delay type subfield, an ID subfield, a queue size subfield, a queue size scaling subfield, and/or a delay unit field, as described above with reference to FIG. 5. In some examples, the delay reporting circuit 842 (e.g., in coordination with the transceiver 810) may output the delay status report.

At block 1008, the STA 800 may obtain a resource allocation for transmission of the one or more packets according to the information relating to the delay condition. That is, an AP may transmit a trigger frame to the STA 800, the trigger frame including a resource allocation for the STA 800 to transmit the one or more packets. Here, the resource allocation may be configured according to the delay status report. In some examples, the communication controller 840 (e.g., in coordination with the transceiver 810) may obtain the resource allocation from the AP.

At block 1010, the STA 800 may transmit the one or more packets according to the resource allocation. That is, the STA 800 may use the resources allocated to it for transmission of the one or more packets. In some examples, the communication controller 840 (e.g., in coordination with the transceiver 810) may transmit the one or more packets.

### Example Operations of an Access Point

FIG. 11 is a flow chart illustrating an exemplary process 1100 for an access point (AP) in accordance with some aspects of the present disclosure. As described below, a particular implementation may omit some or all illustrated features, and may not require some illustrated features to implement all embodiments. In some examples, the AP 900 illustrated in FIG. 9 may be configured to carry out the process 1100. In some examples, any suitable apparatus or means for carrying out the functions or algorithm described below may carry out the process 1100.

At block 1102, the AP 900 may obtain a capability information message from a STA. The capability information message may be any suitable message in any suitable format, indicating a STA capability of using a delay status report message. Here, the capability information message may indicate a capability of the STA to transmit a delay status report message for reduced latency and improved QoS. In some examples, the communication controller 940 (e.g., in coordination with the transceiver 910) may obtain the capability information message from the STA.

At block 1104, the AP 900 may obtain, from the STA, a delay status report including information relating to a delay condition associated with one or more packets for transmission. For example, a delay status report may include a delay subfield as described above with reference to FIG. 5. In further examples, a delay status report may include one or more of a delay type subfield, an ID subfield, a queue size subfield, a queue size scaling subfield, and/or a delay unit field, as described above with reference to FIG. 5. In some examples, the communication controller 940 (e.g., in coordination with the transceiver 910) may obtain the delay status report from the STA.

At block 1106, the AP 900 may schedule resources for the STA to transmit the one or more packets, based on the information relating to the delay condition. For instance, the AP may prioritize the STA relative to other STAs to enable the STA to meet a reported delay bound. In another example, the AP may prioritize the STA relative to other STAs based on a reported HOL delay. In some examples, the resource allocation circuit 942 may schedule the resources for the STA.

At block 1108, the AP 900 may output, for transmission, a resource allocation configuring the STA to transmit the one or more packets according to the scheduled resources. That is, the AP 900 may transmit a trigger frame to the STA, the trigger frame including a resource allocation for the STA to transmit the one or more packets. In some examples, the communication controller 940 (e.g., in coordination with the transceiver 910) may output the resource allocation.

At block 1110, the AP 900 may obtain, from the STA, the one or more packets according to the resource allocation. That is, the STA may use the resources allocated to it for transmission of the one or more packets. In some examples, the communication controller 940 (e.g., in coordination with the transceiver 910) may obtain the one or more packets.

### Further Examples Having a Variety of Features

Implementation examples are described in the following numbered clauses:
Clause 1: a method of wireless communication at a station, the method comprising: obtaining one or more packets for transmission, the one or more packets being associated with a delay condition: outputting, for transmission, a report comprising information relating to the delay condition associated with the one or more packets; and obtaining a resource allocation for transmission of the one or more packets according to the information relating to the delay condition.
Clause 2: the method of clause 1, wherein the information relating to the delay condition of the one or more packets comprises one of: an amount of time that has elapsed since obtaining the one or more packets for transmission; a time when the one or more packets were obtained with respect to a timing synchronization function (TSF) timer: a delay bound corresponding to the one or more packets: a delay bound with respect to the TSF timer; a delay bound corresponding to a subset of the one or more packets; or an average delay bound corresponding to the one or more packets.
Clause 3: the method of either of clauses 1-2, wherein the report further comprises a category of the information relating to the delay condition.
Clause 4: the method of any of clauses 1-3, wherein the report further comprises an identifier (ID) subfield indicating an ID corresponding to the one or more packets.
Clause 5: the method of any of clauses 1-4, wherein the report further comprises a queue size field indicating a size corresponding to the one or more packets.
Clause 6: the method of any of clauses 1-5, wherein the report further comprises a queue size scaling field indicating a multiplier to be used for determining the size corresponding to the one or more packets.
Clause 7: the method of any of clauses 1-6, wherein the report further comprises a delay unit field indicating a time unit corresponding to the information relating to the delay condition.
Clause 8: the method of any of clauses 1-7, further comprising outputting, for transmission, a capability information message indicating a station capability associated with the transmission of the report.
Clause 9: the method of any of clauses 1-8, further comprising obtaining, from an access point, a capability information message indicating an access point capability of receiving the report.
Clause 10: the method of any of clauses 1-9, wherein the report is included in an A-control subfield of the high efficiency (HE) variant high throughput (HT) control field in a MAC header.
Clause 11: a method of wireless communication at an access point, the method comprising: obtaining a report from a station, the report comprising information relating to a delay condition associated with one or more packets for transmission; scheduling resources for the station to transmit the one or more packets based on the information relating to the delay condition: and outputting, for transmission to the station, a resource allocation configuring the station to transmit the one or more packets according to the scheduled resources.
Clause 12: the method of clause 11, wherein the information relating to the delay condition of the one or more packets comprises one of: an amount of time that has elapsed since the station obtained the one or more packets for transmission: a time when the one or more packets were obtained with respect to a timing synchronization function (TSF) timer; a delay bound corresponding to the one or more packets; a delay bound with respect to the TSF timer; a delay bound corresponding to a subset of the one or more packets; or an average delay bound corresponding to the one or more packets.
Clause 13: the method of either of clauses 11-12, wherein the report further comprises a category of the information relating to the delay condition, and wherein the scheduling resources for the station comprises prioritizing the station based on the category of the information relating to the delay condition.
Clause 14: the method of any of clauses 11-13, wherein the report further comprises an identifier (ID) subfield indicating an ID corresponding to the one or more packets, and wherein the scheduling resources for the station is based on the ID corresponding to the one or more packets.
Clause 15: the method of any of clauses 11-14, wherein the report further comprises a queue size field indicating a size corresponding to the one or more packets, and wherein the scheduling resources for the station comprises prioritizing the station based on the size corresponding to the one or more packets.
Clause 16: the method of any of clauses 11-15, wherein the report further comprises a queue size scaling field indicating a multiplier, and the method further comprising multiplying the size corresponding to the one or more packets with the multiplier, wherein the scheduling resources for the station is based on the multiplying.
Clause 17: the method of any of clauses 11-16, wherein the report further comprises a delay unit field indicating a time unit corresponding to the information relating to the delay condition, wherein the scheduling resources for the station is based on the time unit corresponding to the information relating to the delay condition.
Clause 18: the method of any of clauses 11-17, further comprising: obtaining a capability information message from the station, the capability information message indicating a capability of the station to transmit the report, wherein the scheduling resources for the station is based on the capability of the station to transmit the report.
Clause 19: the method of any of clauses 11-18, further comprising: outputting, for transmission, a capability information message indicating a capability of the access point to receive the report, wherein the scheduling resources for the station is based on the capability of the access point to receive the report.
Clause 20: the method of any of clauses 11-19, wherein the report is included in an A-control field of the high efficiency (HE) variant high throughput (HT) control field in a MAC header.
Clause 21: an apparatus for wireless communications comprising means for performing a method in accordance with any one of clauses 1-10.
Clause 22: an apparatus for wireless communications comprising means for performing a method in accordance with any one of clauses 11-20.
Clause 23: a non-transitory computer-readable medium comprising instructions that, when executed by an apparatus, cause the apparatus to perform a method in accordance with any one of clauses 1-10.
Clause 24: a non-transitory computer-readable medium comprising instructions that, when executed by an apparatus, cause the apparatus to perform a method in accordance with any one of clauses 11-20.
Clause 25: an apparatus for wireless communications, comprising: a memory comprising instructions; and one or more processors configured to execute the instructions to cause the apparatus to perform a method in accordance with any one of clauses 1-10.
Clause 26: an apparatus for wireless communications, comprising: a memory comprising instructions; and one or more processors configured to execute the instructions to cause the apparatus to perform a method in accordance with any one of clauses 11-20.
Clause 27: a station comprising: a transceiver; a memory comprising instructions; and one or more processors configured to execute the instructions to cause the station to perform a method in accordance with any one of clauses 1-10, wherein the transceiver is configured to: transmit the report and receive the resource allocation.
Clause 28: an access point comprising: a transceiver; a memory comprising instructions; and one or more processors configured to execute the instructions to cause the station to perform a method in accordance with any one of clauses 11-20, wherein the transceiver is configured to: receive the report from the station, and transmitting the resource allocation to the station.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices. e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example. “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “communicating” broadly encompasses a variety of signaling between devices. Communicating may include one or both of receiving (or obtaining) or transmitting (outputting for transmission).

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1: An apparatus configured for wireless communication, the apparatus comprising:
a memory comprising instructions; and
a processor configured to execute the instructions and cause the apparatus to:
obtain one or more packets for transmission, the one or more packets being associated with a delay condition;
output, for transmission, a report comprising information relating to the delay condition associated with the one or more packets; and
obtain a resource allocation for transmission of the one or more packets according to the information relating to the delay condition.

2: The apparatus of claim 1, wherein the information relating to the delay condition of the one or more packets comprises one of:
an amount of time that has elapsed since obtaining the one or more packets for transmission;
a time when the one or more packets were obtained with respect to a timing synchronization function (TSF) timer;
a delay bound corresponding to the one or more packets;
a delay bound with respect to the TSF timer;
a delay bound corresponding to a subset of the one or more packets; or
an average delay bound corresponding to the one or more packets.

3: The apparatus of claim 1, wherein the report further comprises a category of the information relating to the delay condition.

4: The apparatus of claim 1, wherein the report further comprises an identifier (ID) subfield indicating an ID corresponding to the one or more packets.

5: The apparatus of claim 1, wherein the report further comprises a queue size field indicating a size corresponding to the one or more packets.

6: The apparatus of claim 5, wherein the report further comprises a queue size scaling field indicating a multiplier to be used for determining the size corresponding to the one or more packets.

7: The apparatus of claim 1, wherein the report further comprises a delay unit field indicating a time unit corresponding to the information relating to the delay condition.

8: The apparatus of claim 1, wherein the processor is further configured to cause the apparatus to output, for transmission, a capability information message indicating a station capability associated with the transmission of the report.

9: The apparatus of claim 1, wherein the processor is further configured to cause the apparatus to obtain, from an access point, a capability information message indicating an access point capability of receiving the report.

10: The apparatus of claim 1, wherein the report is included in an A-control subfield of a high efficiency (HE) variant high throughput (HT) control field in a MAC header.

11: A station configured for wireless communication, comprising:
a memory comprising instructions;
a transceiver; and
a processor configured to execute the instructions and cause the station to:
obtain one or more packets for transmission, the one or more packets being associated with a delay condition;
transmit, via the transceiver, a report comprising information relating to the delay condition associated with the one or more packets; and
receive, via the transceiver, a resource allocation for transmission of the one or more packets according to the information relating to the delay condition.

12: An apparatus configured for wireless communication, the apparatus comprising:
a memory comprising instructions; and
a processor configured to execute the instructions and cause the apparatus to:
obtain a report from a station, the report comprising information relating to a delay condition associated with one or more packets for transmission;
schedule resources for the station to transmit the one or more packets based on the information relating to the delay condition; and
output, for transmission to the station, a resource allocation configuring the station to transmit the one or more packets according to the scheduled resources.

13: The apparatus of claim 12, wherein the information relating to the delay condition of the one or more packets comprises one of:
an amount of time that has elapsed since the station obtained the one or more packets for transmission;
a time when the one or more packets were obtained with respect to a timing synchronization function (TSF) timer;
a delay bound corresponding to the one or more packets;
a delay bound with respect to the TSF timer;
a delay bound corresponding to a subset of the one or more packets; or
an average delay bound corresponding to the one or more packets.

14: The apparatus of claim 12, wherein the report further comprises a category of the information relating to the delay condition, and
wherein the processor, being configured to schedule resources for the station, is further configured to prioritize the station based on the category of the information relating to the delay condition.

15: The apparatus of claim 12, wherein the report further comprises an identifier (ID) subfield indicating an ID corresponding to the one or more packets, and
wherein the processor, being configured to schedule resources for the station, is configured to schedule the resources for the station based on the ID corresponding to the one or more packets.

16: The apparatus of claim 12, wherein the report further comprises a queue size field indicating a size corresponding to the one or more packets, and
wherein the processor, being configured to schedule resources for the station, is further configured to prioritize the station based on the size corresponding to the one or more packets.

17: The apparatus of claim 16, wherein the report further comprises a queue size scaling field indicating a multiplier,
wherein the processor is further configured to multiply the size corresponding to the one or more packets with the multiplier, and
wherein the processor, being configured to schedule resources for the station, is further configured to schedule the resources for the station based on the multiplying.

18: The apparatus of claim 12, wherein the report further comprises a delay unit field indicating a time unit corresponding to the information relating to the delay condition, and
wherein the processor, being configured to schedule resources for the station, is configured to schedule the resources for the station based on the time unit corresponding to the information relating to the delay condition.

19: The apparatus of claim 12, wherein the processor is further configured to cause the apparatus to:
obtain a capability information message from the station, the capability information message indicating a capability of the station to transmit the report, and
wherein the processor, being configured to schedule resources for the station, is further configured to schedule the resources for the station based on the capability of the station to transmit the report.

20: The apparatus of claim 12, wherein the processor is further configured to cause the apparatus to:
output, for transmission, a capability information message indicating a capability of the access point to receive the report, and
wherein the processor, being configured to schedule resources for the station, is further configured to schedule the resources for the station based on the capability of the access point to receive the report.

21: The apparatus of claim 12, wherein the report is included in an A-control field of the high efficiency (HE) variant high throughput (HT) control field in a MAC header.

22: The apparatus of claim 12, further comprising a transceiver configured to:
receive the report from the station; and
transmit the resource allocation,
wherein the apparatus is configured as an access point.
